(19) United States
(12) Patent Application Publication
(10) Pub. No.: US 2002/0120608 A1
(43) Pub. Date: Aug. 29, 2002

(54) Apparatus and method for transcopying data

(76) Inventor: Jung-kwon Heo, Seoul (KR)

Correspondence Address: STAAS & HALSEY LLP, 700 11TH STREET, NW, SUITE 500, WASHINGTON, DC, 20001, US

(21) Appl. No.: 09/960,504

(22) Filed: Sep. 24, 2001

Related U.S. Application Data
(60) Provisional application No. 60/270,618, filed on Feb. 23, 2001.

(30) Foreign Application Priority Data
Feb. 26, 2001 (KR) 2001-9601

(51) Int. Cl. G06F 7/00

(52) U.S. Cl. 707/1

(57) ABSTRACT

A data transcopying apparatus has a coding method confirming unit to confirm an original coding method applied to original content data, a transcopying unit to generate copied content data by converting the original content data so that the copied content data can be decoded by a second coding method, and a management information recording unit to record information indicating that the original content data was copied in a management information area of the original content data, and to record information indicating that the copied content data was transcopied from the original content data in a management information area of the copied content data to reproduce the encoded content data in a content player of the user by changing the coding method, and to control rights information so that the copyright of the content data is not infringed by the transcopying.

### CROSS-REFERENCE TO RELATED APPLICATIONS

This application claims the benefit of Korean Application No. 2001-9601, filed Feb. 26, 2001, in the Korean Industrial Property Office, and U.S. Provisional Application No. 60/270,618 filed Feb. 23, 2001 in the U.S. Patent and Trademark Office, the disclosures of which are incorporated herein by reference.

### BACKGROUND OF THE INVENTION

1. Field of the Invention

The present invention relates to converting data, and more particularly, to an apparatus and method to convert data into a different coding system to generate converted data, and to copy the converted data instead of the original data (hereinafter referred to as “transcopying data”).

2. Description of the Related Art

When a person buys data, such as music or video data, on the Internet, the buyer receives the data that has been encoded by a coding method applied by a seller. If the buyer has a decoder capable of reproducing the data, there is no problem. However, if the buyer's decoder is incapable of reproducing the data encoded by the seller's coding method, the buyer cannot enjoy the data.

### SUMMARY OF THE INVENTION

To solve the above and other problems, it is an object of the present invention to provide an apparatus and method to transcopy data, where original content data is transcopied and provided so that the original content data can be decoded by a different coding method should a decoder of a user's player use a coding method different from the coding method of the original content data.

It is another object of the present invention to provide a content data structure containing rights information such as copyright information when the content data is transcopied.

Additional objects and advantages of the invention will be set forth in part in the description which follows and, in part, will be obvious from the description, or may be learned by practice of the invention.

To accomplish the above and other objects, an apparatus according to an embodiment of the present invention has a coding method confirming unit to confirm an original coding method applied to original content data, a transcopying unit to generate copied content data by converting the original content data so that the copied content data can be decoded by another coding method different from the original coding method, and a management information recording unit to record information indicating that the original content data is copied in a management information area of the original content data, and recording information indicating that the copied content data is transcopied from the original content data in a management information area of the copied content data.

According to an aspect of the present invention, the transcopying unit comprises a decoding unit to decode the original content data according to the original coding method, and an encoding unit to generate copied content data by encoding the decoded content data using another coding method.

According to another aspect of the present invention, the transcopying unit has a reverting unit to restore the original content data from the copied content data by recording information indicating that rights information is restored from the copied content data in a management information area of the original content data after confirming whether the copied content data is transcopied from the corresponding original content data.

According to another embodiment of the present invention, a method of transcopying data includes confirming an original coding method applied to original content data, setting another coding method that is different from the original coding method, and generating copied content data, which can be decoded by the another coding method, by converting the original content data.

According to an aspect of the present invention, when reverting the copied content data to the original content data, the method further includes confirming whether the copied content data is transcopied from the original content data, and recording information indicating that rights information is restored from the copied content data which is transcopied from the original content data in a management information area of the original content data.

According to a further embodiment of the present invention, a content data structure includes content data, data file information that is unique to the content data so that the content data can be distinguished from other content data, and a rights management information area in which information is recorded indicating whether the content data is original content data or copied content data transcopied from original content data, and rights information related to data transcopying are recorded, where the content data structure, and information on the corresponding original content data is recorded in the data file information area of a copied content data, and management information for the original content data and the copied content data changes according to transcopying situations.

According to an aspect of the present invention, the management information includes information on the number of times that the original content data can be copied, information used to distinguish the original content data from the copied content data, and information on a coding method of the content data.

### BRIEF DESCRIPTION OF THE DRAWINGS

The above and other objects and advantages of the present invention will become more apparent and more readily appreciated by describing in detail preferred embodiments thereof with reference to the accompanying drawings in which:

FIG. 1 is a block diagram of a data transcopying apparatus according to an embodiment of the present invention;

FIG. 2 is an example of information contained in original content data or copied content data according to an embodiment of the present invention;

FIGS. 3A and 3B are diagrams to explain the transcopying unit shown in FIG. 1, where FIG. 3A shows an example when the content data is music data and the original coding method of the original content data is different from the coding method of a content player, and where FIG. 3B is a detailed block diagram of the transcopying unit shown in FIG. 1;

FIG. 4 is a detailed block diagram of a reverting unit shown in FIG. 1;

FIG. 5 is an example of receiving content data through a communications network, such as the Internet, and using the content data according to an embodiment of the present invention;

FIG. 6 is a flowchart of a method for transcopying data according to an embodiment of the present invention; and

FIG. 7 is a flowchart of a method for reverting copied content data, which was transcopied by the method shown in FIG. 6, into the original content data.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

Hereinafter the conversion of data from an original coding system into a different coding system and copying the converted data will be referred to as “transcopying data.”

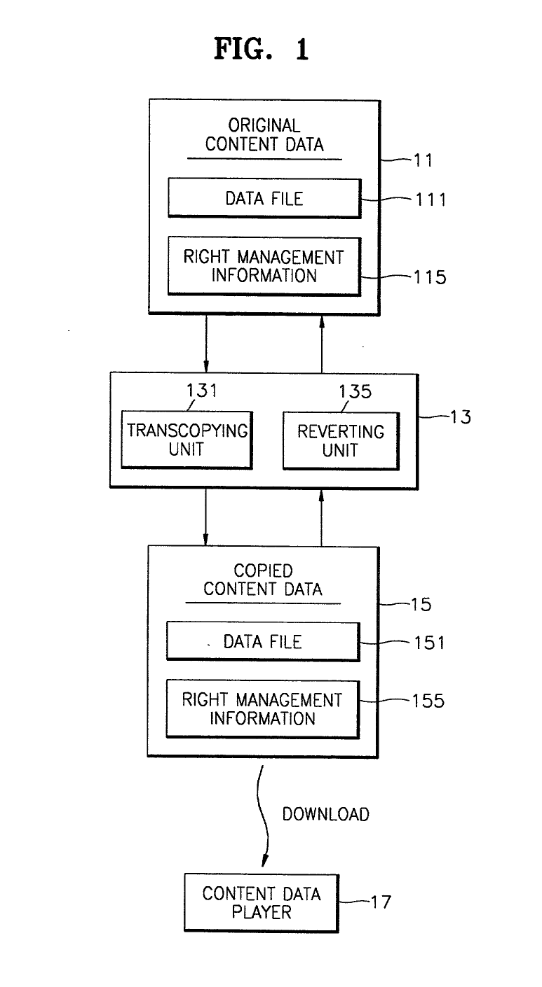

FIG. 1 shows a block diagram of a data transcopying apparatus 13 according to an embodiment of the present invention. The transcopying apparatus 13 communicates data with a content player 17, which is a device with which a user directly reproduces content data such as an audio player. The content player 17 can be any player for video or other types of data that can be reproduced in a content player 17. The data transcopying apparatus 13 according to the present invention can be regarded as an apparatus that provides data appropriate to the content player 17, and can be generally installed in a personal computer, in a server for providing data, or in any general or special purpose computer. The content player 17 may be a device that is separate from a computer, such as a digital television or an MP3 player, or may be implemented in a computer as hardware or software. Thus, it is understood that the data transcopying apparatus 13 and the content player 17 may be physically separated or combined.

The data transcopying apparatus 13 has a transcopying unit 131 to transcopy original content data 11 to become copied content data 15, and a reverting unit 135 to revert the copied content data 11 back to the original content data 15. The transcopying unit 131 receives the original content data 11, which may be previously stored in a memory or a disc, or may be transmitted online through a communications network. The copied content data 15, which is transcopied in the transcopying unit 131, is encoded by a method appropriate for the content player 17 of the user.

The original content data 11 contains a data file 111 on the content data, and rights management information 115 related to copyrights. Similarly, the copied content data 15 contains a data file 151 on the transcopied content data and the rights management information related to copyrights. Rights management information 155 may include information on content rights related to copyrights or licenses to use, duplicate, and/or alter content data, and information directly or indirectly related to the rights contents. For example, the rights management information 155 could include the date when the copyright came into effect, the dates when the content data is used, and the number of times the content data has been transcopied. Also, the rights management information 155 may include information for ordinary data management, such as the file size and the date of generation.

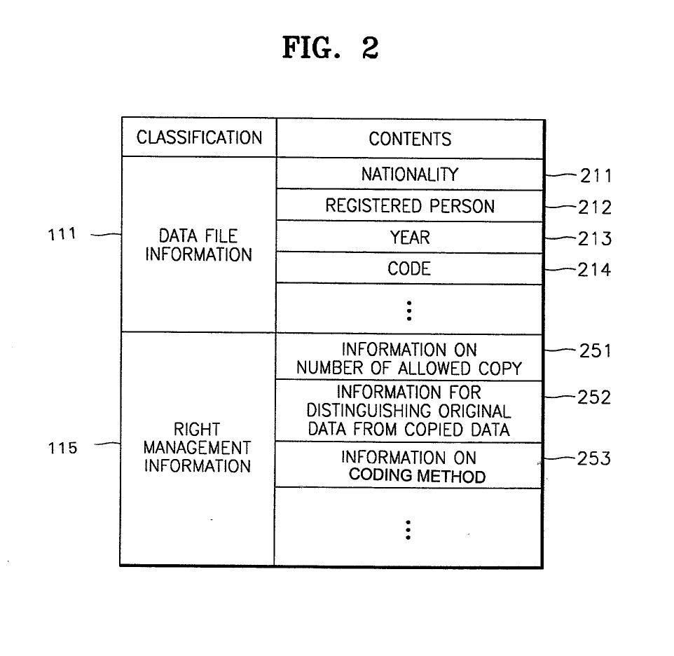

FIG. 2 shows information contained in the original content data 11 according to an embodiment of the invention, the content data 11 includes data file information 111 that is uniquely assigned to the content data 11 so that the content data 11 can be distinguished from other content data. The content data 11 also includes rights management information that includes rights information, such as copyrights of the content data. It is understood that the copied content data 15 has the same structure as the original content data 11 shown in FIG. 2.

The data file information 111 includes information on the producer, seller, or copyright holder of the content data 11 and can include unique code information of the content data 11. For example, the data file information 111 includes information on the nationality of the copyright holder 211, a registered person 212, authoring year 213, and unique code 214. The rights management information 115 includes rights information related to transcopying, including information on the number of times the content data 11 can be copied 251, information to distinguish the original content data from the copied content data 252, and information on a coding method of content data 253.

The original content data 11 and the copied content data 15 thereof may confirm the identity of both content data, by commonly sharing the data file information 111. Also, the copied content data 15 can prepare separate information so that the relation of the copied content data and the original content data 11 can be confirmed later.

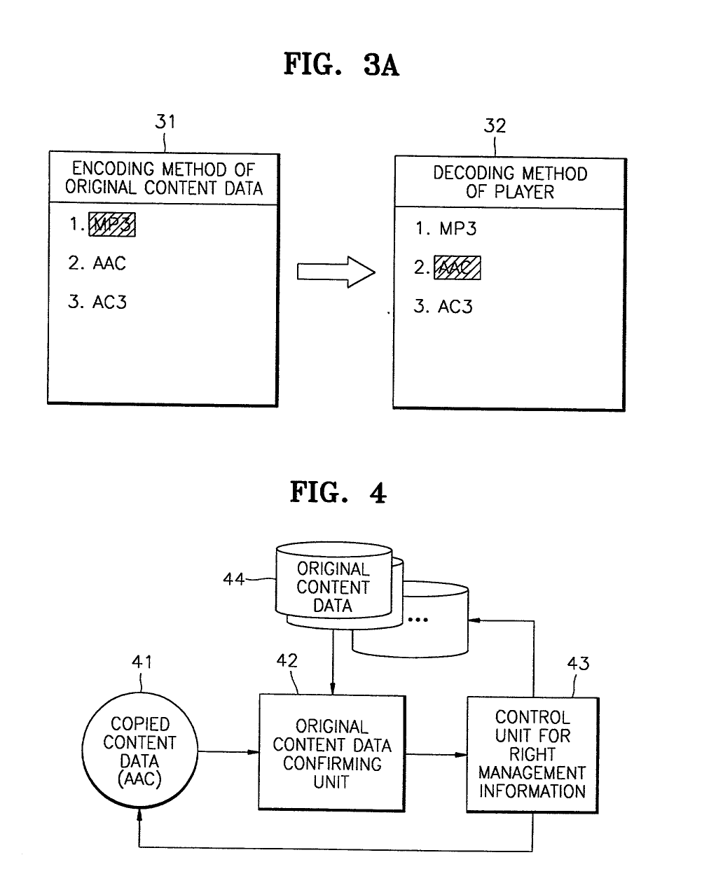

FIGS. 3A and 3B are diagrams to explain a transcopying unit 131 shown in FIG. 1 according to an embodiment of the invention. FIG. 3A shows an example in which the content data 11 is music data, and the coding method of the original content data 11 is different from the coding method of a content player 17. In FIG. 3A, the encoding method 31 of the original content data 11 is an MP3 method, while the decoding method 32 of the content player 17 is an AAC method. The encoding method applied to the original content data 11 or the decoding method of the content player 17 can be found using hardware or software, or the user can directly input the decoding method. Normally, the encoding method of the original content data is found by analyzing the content data, and the decoding method of the content player is selected by using user input.

FIG. 3B is a detailed block diagram of the transcopying unit 131 shown in FIG. 1, and shows an example in which MP3-type original content data 33 is transcopied into AAC-type copied content data 38. An encoding method confirming unit 34 confirms a coding method applied to the original content data 33 by analyzing the structure of the content data 33. When the content provider provides information on the coding method, it is understood that the user can set a coding method without separately confirming the coding method using the confirming unit 34.

A decoder unit 35 can be various kinds of decoders such as an MP3 decoder 351, an MC decoder 352, an AC3 decoder 353 or other similar decoders used to decode the music data. The decoder unit 35 selects a decoder corresponding to the coding method of the original content data 33, decodes the original content data 33, and outputs the decoded data as standard data 36. As shown, the standard data 36 may be data which is reproduced by the original content data 33, or data encoded by a predetermined coding method.

An encoder unit 37 also has various kinds of encoders such as an MP3 encoder 371, an MC encoder 372, an AC3 encoder or other similar encoders used to encode music data. The encoder unit 37 selects an encoder corresponding to a decoding method set for the content player 17, converts the standard data 36, and generates copied content data 38.

A control unit for rights management information 39 changes the rights management information 115, 155 of the original content data 33 and the copied content data 38 according to a transcopying situation. For example, the rights management information 115 of the original content data 33 includes copy information indicating that the original content data 33 is copied to the copied content data 38. The copy information may further include information indicating whether the original content data 33 was itself copied or transcopied, or information on the frequency or amount of the copying, and the copying date. The rights management information 155 of the copied content data 38 includes information indicating that the copied content data 38 is transcopied from the original content data 33.

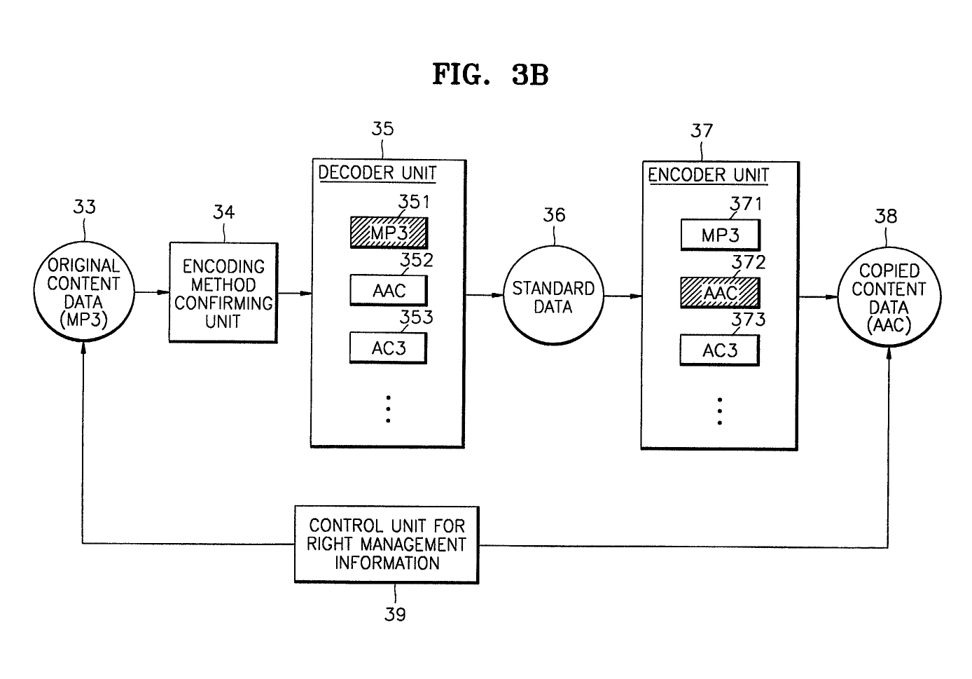

FIG. 4 is a detailed block diagram of a reverting unit 135 shown in FIG. 1. The reverting unit 135 reverts the copied content data 41 into the corresponding original content data 44. An original content data confirming unit 42 confirms the original content data 44 corresponding to the copied content data 41 using information that can confirm original content data 44, such as data file information 151 in the copied content data 41. As shown, the sets of original content data 44 may be content data stored in a storage means, such as a hard disc or a compact disc of the user computer, or content data 44 stored in a server to provide content data through a communications network, such as the Internet so as to form a virtual library.

If the original content data 44 corresponds to the copied content data, the rights management information control unit 43 restores the original content data 44 from the copied content data 41 and the information indicating that the rights information was restored from the transcopied content data 41 is recorded in the rights management information area of the original content data 115. Also, information indicating that the copied content data 41 was restored to the original content data 44 is recorded in the rights management information area of the copied content data 41, or the rights management information is changed so that the copied content data 41 cannot be used. Unlike the transcopying process, a reverting process does not need a data converting process and only rights information is restored.

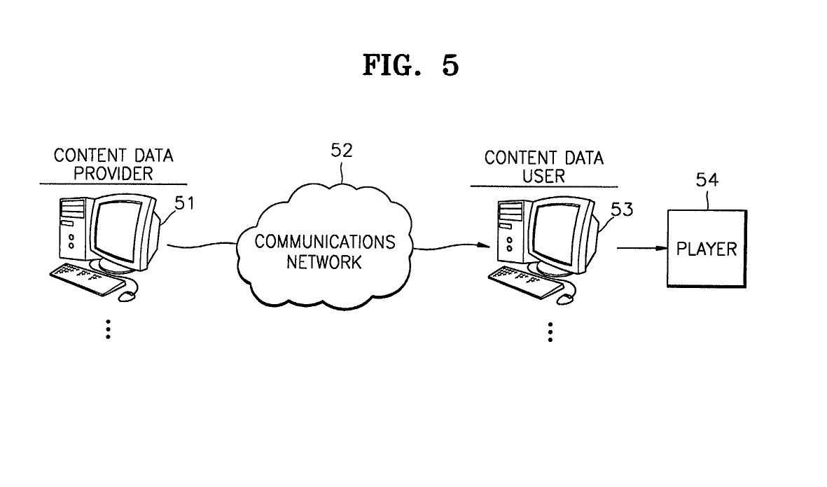

FIG. 5 is an example of receiving content data through a communications network 52, such as the Internet, and using the content data. A content data provider 51 provides original content data 11 which is coded by a coding method selected by the content data provider 51. A content data user 53 receives the original content data 11 through the communications network 52. If a content player 54 of the user supports the coding method of the original content data 11, the user can directly reproduce the content data 11. If the content player 54 does not support the coding method of the original content data, a transcopying process is needed. Software (or hardware, if necessary) to perform the transcopying process of the present invention may be provided by the content data provider 51 or the user 53 may prepare the software.

The content data user 53 confirms the coding method of the original content data 11 before or after the original content data 11 is provided, and can get copied content data 15 coded appropriately for the content player 54. The content data provider 51 may then directly provide the original content data 11 to the content data user 53 (i.e., the user computer 53 may download all the original content data 11 from the content data provider 51 and store the original content data 11 in the user computer 53). On the other hand, the content data provider 51 may also provide copied content data 15 with or without the original content data 11 after generating the copied content data 15 according to the original content data 11 and its coding method selected by the user 53. Thus, the transcopying process may be performed by the content data provider 51 or the content data user 53.

If the user's player 54 is installed in the user computer 53, the downloaded content data 11 or 15 can be directly reproduced. If the user's player 54 is separate from the user computer 53, the copied content data 15 is downloaded to the user player 54 and reproduced. If the user 53 desires to restore the original content data 11 from the copied content data 15, the user 53 can restore the rights by changing the rights management information 115 or 155 in each content data 11 or 15. Therefore, by changing the rights management information 115 or 155 of the content data 11 or 15 according to a transcopying or reverting method, the content data provider's 51 loss due to copyright infringement can also be prevented.

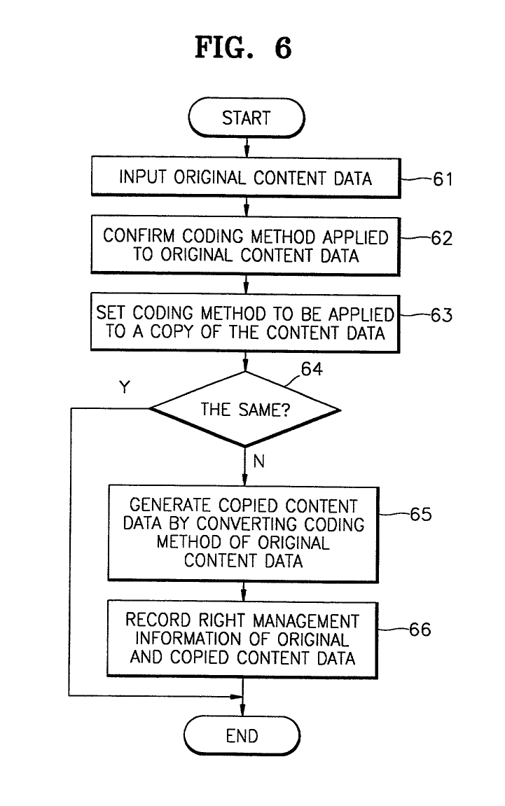

FIG. 6 is a flowchart of a method for transcopying data according to an embodiment of the present invention. The original content data 11, which is provided through a communications network or is stored in a user computer, is input in operation 61. The coding method applied to the input original content data 11 is confirmed in operation 62. A coding method of a content player 17 by which the original content data 11 is desired to be reproduced is then set. Specifically, the coding method of copied content data 15 is set in operation 63. If it is determined in operation 64 that the coding method of the content player 17 is different from the coding method of the original content 11, the copied content data 15 is generated by converting the coding method of the original content data 11 in operation 65. By transcopying the data, the information indicating that the original content data 11 is transcopied to the copied content data 15 and is recorded in a rights management information area 115 of the original content data 11 in operation 66. In addition, information indicating that the copied content data 15 is transcopied from the original content data 11 is recorded in a rights management information area 155 of the copied content data 15 in operation 66.

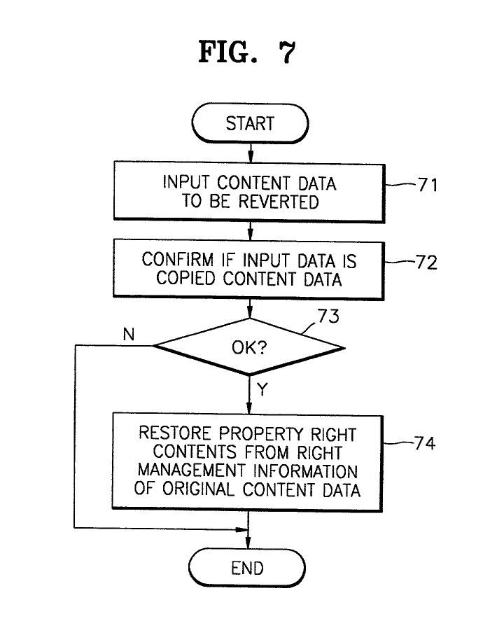

FIG. 7 is a flowchart of a method for reverting (restoring) the copied content data 15 that was transcopied according to the method shown in FIG. 6 back into the original content data 11. The content data to be reverted is input in operation 71. It is determined whether or not the input content data is copied content data 15 in operation 72. The content data may be stored in a memory or a disc of a user computer. Also, the content data may be downloaded from a content player to the computer, or may be used by connecting a signal line between the content player and the computer.

If the content data is determined to be copied content data 15 in operation 73, the original content data 11 corresponding to the copied content data 15 is found and information indicating that the rights information is restored from the copied content data 15 is recorded in the rights management information area 115 of the original content data 11 in operation 74.

Although a detailed explanation of the operations is not given in FIGS. 6 and 7, a more detailed data transcopying method can be understood by a person of ordinary skill in the art, based on the explanation of FIGS. 1 through 5. For example, the original content data can be provided through an online communications network, such as the Internet, or the transcopying process is performed by a content data provider or a content data user. Also, the rights management information may be implemented in various ways during a transcopying process or a reverting process.

Although music data is explained as an embodiment of the present invention, the present invention can be used with still picture or moving picture data. For example, the transcopying method can be used with still picture data such as various GIF, JPG, TIF, etc. In addition to audio/video data, the present invention can be used with all types of data, such as electronic publications, that a user can use by decoding the data according to a coding method corresponding to the coding method of content data.

The present invention may be embodied in a software code that is encoded on a computer readable recording medium and is readable by a computer. The computer readable recording medium may be any kind on which computer readable data are stored. The computer readable recording media may be storage media such as magnetic storage media (e.g., ROM's, floppy disks, hard disks, etc.), optically readable media (e.g., CD-ROMs, DVDs, etc.), firmware, or carrier waves (e.g., transmissions over the Internet). Also, the computer readable recording medium can be scattered on computer systems connected through a network and can store and execute a computer readable code in a distributed mode.

As described above, the apparatus and method for transcopying data of the present invention allows content data to be reproduced in a user's player by changing the coding method of the content data when the content data is provided by, or purchased from a content data provider through a communications network such as the Internet, and is encoded by a coding method which the user's player does not support. At the same time, by transcopying data, rights management information is controlled so that the copyrights related to the content data are not infringed. Therefore, the rights of the content data provider is not damaged and the user can reproduce the content data in the most appropriate way.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to convert original content data into a different coding system to generate converted content data and to copy the converted content data instead of the original content data, comprising:
a coding method confirming unit to confirm an original coding method applied to the original content data;
a transcopying unit to convert the original content data into copied content data that is decodable according to a different coding method; and
a management information recording unit to record information indicating that the original content data has been copied in a management information area of the original content data, and to record information indicating that the copied content data has been transcopied from the original content data in a management information area of the copied content data.

2. The data transcopying apparatus of claim 1, wherein said transcopying unit comprises:
a decoding unit to decode the original content data according to the original coding method; and
an encoding unit to encode the decoded content data using the different coding method to generate the copied content data.

3. The data transcopying apparatus of claim 1, further comprising:
a reverting unit to record information indicating that rights information is restored from the copied content data in the management information area of the original content data, and to confirm whether the copied content data is transcopied from the corresponding original content data so as to restore the original content data from the copied content data.

4. The data transcopying apparatus of claim 1, wherein the management information of the original and/or copied content data includes one of information on a number of times that the content data can be copied, information to distinguish the original content data from the copied content data, and information on an original or different coding methods of the original or copied content data.

5. A content data structure stored on a recordable medium, the content data comprising:
content data comprising one of original and copied content data;
data file information unique to said content data so that said content data is distinguishable from other content data, said data file information comprising information on the corresponding original content data where the content data is copied content data; and
a rights management information area to indicate whether said content data is the original content data or the copied content data transcopied from the original content data, and to indicate rights information related to data transcopying,
wherein said rights management information for the original content data and the copied content data changes according to transcopying situations.

6. The content data structure of claim 5, wherein said rights management information includes one of information on a number of times the content data is allowed to be copied, information to distinguish the original content data from the copied content data, and information on a coding method of said content data.

7. A method for transcopying data, the method comprising:
confirming an original coding method applied to original content data;
setting a different coding method than the original coding method; and
converting the original content data to generate copied content data to be decoded by the different coding method.

8. The data transcopying method of claim 7, wherein said converting the original content data comprises recording information indicating that the original content data was transcopied into the copied content data is recorded in a rights management information area of the original content data, and recording information indicating that the copied content data was transcopied from the original content data in a rights management information area of the copied content data.

9. The data transcopying method of claim 7, further comprising reverting the copied content data to the original content data, said reverting comprising:
confirming whether the copied content data is transcopied from the original content data; and
recording information indicating that the information is restored from the copied content data in a rights management information area of the original content data.

10. A computer-readable medium encoded with a method for transcopying executable by a computer, the transcopying method comprising:
confirming an original coding method applied to original content data;
setting a different coding method than the original coding method; and
converting the original content data to generate copied content data that is decoded by the different coding method.

11. An apparatus to convert data into a different coding system, comprising:
a copying unit to create copied content data from original content data, where the original and copied content data are decoded using different decoding methods; and
an information recording unit to record information in one of the original and the copied content data that relates the original and the copied content data.

12. The apparatus of claim 11, wherein the information is copied into both the original and the copied content data and identifies the copied content data as copied from the original content data.

13. The apparatus of claim 11, wherein the information is copied into both the original and the copied content data so as to identify rights of a user to further copy the copied content data and the original content data.

14. The apparatus of claim 11, wherein the information is copied into both the original and the copied content data so as to identify the respective coding methods of the copied content data and the original content data.

15. The apparatus of claim 11, wherein said coding unit comprises:
a decoding unit that decodes the original content data coded into standard data; and
an encoding unit to encode the standard data using a different coding method from a coding method used to encode the original content data.

16. The apparatus of claim 15, wherein the information is copied into both the original and the copied content data, where the information
distinguishes the copied content data from the original content data,
identifies rights of a user to further copy the copied content data and the original content data, and
identifies the respective coding methods of the copied content data and the original content data.

17. The apparatus of claim 11, wherein the information is copied into both the original and the copied content data, where the information
distinguishes the copied content data from the original content data,
identifies rights of a user to further copy the copied content data and the original content data, and
identifies the respective coding methods of the copied content data and the original content data.

18. The apparatus of claim 17, wherein the copied content data and the original content data further include ownership information, where the ownership information is the same for both the original and copied content data.

19. The apparatus of claim 18, further comprising an encoding method confirming unit to detect the coding method of the original content data using the information of the original content data.

20. The apparatus of claim 19, further comprising a network interface connecting the apparatus to a network, wherein the original content data is received over the network.

21. The apparatus of claim 19, further comprising a disk drive, wherein the original content data is received from a disk mounted in said disk drive.

22. The apparatus of claim 16, wherein the decoding unit comprises decoders to decode using corresponding coding methods, and the decoding unit selects one of the decoders to decode the original content data using the information identifying the coding method of the original content data.

23. The apparatus of claim 22, wherein the encoding unit comprises encoders to encode content data of multiple coding methods, and the encoding unit selects one of the encoders to encode the standard data according to the selected coding method of the copied content data.

24. The apparatus of claim 19, further comprising a network interface connecting the apparatus to a network, wherein the copied content data is sent over the network to a content data user.

25. A reverting unit to revert copied content data into corresponding original content data from which the copied content data was copied, comprising:
a confirming unit to confirm that the copied content data corresponds to the original content data using identification information in the copied and original content data; and
a control unit to change rights information in the copied and original content data so that the copied content data cannot be reproduced in a content player, and the original content data reflects that the copied content data cannot be reproduced.

26. The reverting unit of claim 25, wherein said confirming unit identifies and finds the corresponding original content data using identification information in the copied content data.

27. The reverting unit of claim 25, further comprising a network interface connecting the reverting unit to a network, wherein the copied content data is received over the network from a content data user to be reverted.

28. An apparatus to distribute content data, comprising:
a copying unit to create copied content data from original content data, where the original and copied content data are decoded using different decoding methods;
a confirming unit to confirm that the copied content data corresponds to the original content data using identification information in the copied and original content data; and
a control unit to
after said copying unit creates the copied content data, to insert identification information in the copied content data relating the copied contents data and the original content data, and to insert information in the original and copied content data indicating that the original content data was copied by said copying unit, and
revert the copied content data into the original content data by changing rights information in the copied and original content data so that the copied content data cannot be reproduced in a content player, and the original content data reflects that the copied content data cannot be reproduced.

29. The apparatus of claim 28, wherein, to revert the copied content data, said control unit identifies and finds the corresponding original content data using the identification information in the copied content data.

30. The apparatus of claim 28, wherein said control unit further controls information in the original and the copied content data that:
distinguishes the copied content data from the original content data,
identifies rights of a user to further copy the copied content data and the original content data, and
identifies the respective coding methods of the copied content data and the original content data.

31. The apparatus of claim 28, wherein said copying unit comprises:
a decoding unit that decodes the original content data coded into standard data, and
an encoding unit to encode the standard data using a different coding method from a coding method used to encode the original content data.

32. The apparatus of claim 28, further comprising a network interface connecting the apparatus to a network, wherein one of the original and copied content data is distributed over the network.

33. The apparatus of claim 28, further comprising a disk drive, wherein one of the original and copied content data is distributed using a disk mounted in said disk drive.

34. A computer-readable medium encoded with data that is readable by a computer, the medium comprising:
content data;
identification information that indicates whether said content data is original content data, or is copied from the original content data; and
rights information that indicates a right of a user to make copies of said content data.

35. The computer-readable medium of claim 34, further comprising information on a coding method of said content data.

36. The computer-readable medium of claim 34, further comprising ownership information that identifies an owner of said content data.

37. The computer-readable medium of claim 34, wherein, if said content data is copied from the original data, said identification information further distinguishes said content data from the original data.

38. The computer-readable medium of claim 37, further comprising information on a coding method of said content data.

39. The computer-readable medium of claim 38, further comprising ownership information that identifies an owner of said content data.

40. The computer-readable medium of claim 34, further comprising information on a coding method of said content data.

41. The computer-readable medium of claim 40, where said content data comprises audio data.

42. The computer-readable medium of claim 40, where said content data comprises image data.
